(19) United States
(12) Patent Application Publication
(10) Pub. No.: US 2025/0303308 A1
(43) Pub. Date: Oct. 2, 2025

(54) FACILITATION OF DIGITAL COMMUNICATION CHANNEL BETWEEN VIDEO GAME PLAYERS

(71) Applicant: Sony Interactive Entertainment LLC, San Mateo, CA (US)

(72) Inventor: Sean Whitcomb, San Mateo, CA (US)

(21) Appl. No.: 18/623,848

(22) Filed: Apr. 1, 2024

(51) Int. Cl. A63F 13/87; A63F 13/795

(52) U.S. Cl. CPC A63F 13/87; A63F 13/795

(57) ABSTRACT

Clustering models and other types of models may be used to match a first video game player that is proficient in a particular game task with a second video game player that is facing the same task. A secure communication channel between the two players may then be opened on the game network for the first player to coach the second player within the game environment.

### FIELD

The disclosure below relates generally to facilitation of digital communication channels between video game players.

### BACKGROUND

Video game players sometimes have difficulty progressing past a certain aspect of a video game. As recognized herein, current digital communication systems lack the technical capability to provide assistance that is immediate, relevant, and feasible to assist the player in the moment. As such, there are currently no adequate solutions to the foregoing computer-related, technological problem.

### SUMMARY

Accordingly, in one aspect an apparatus includes at least one processor system configured to execute a first model to determine that a first video game player is a video game coach candidate. The at least one processor system is also configured to, based on execution of the first model to determine that the first video game player is a video game coach candidate, present a prompt at a first device of the first video game player regarding whether the first video game player would like to be considered as a video game coach. The at least one processor system is also configured to receive an affirmative response to the prompt and, based on the affirmative response, execute a second model to match the first video game player with a second video game player that the first video game player is to coach in gameplay. The at least one processor system is further configured to, based on the match, facilitate a communication channel between the first device of the first video game player and a second device of the second video game player for the first video game player to coach the second video game player regarding a particular aspect of a video game.

In some example implementations, the first model may be executed to use play proficiency at the particular aspect of the video game in determining that the first video game player is a video game coach candidate. Also in some example implementations, the second model may use one or more clustering algorithms to match the first video game player with the second video game player.

In various example embodiments, the second model may be executed to use play proficiency at a particular task that the second video game player is facing within a particular video game as a factor in matching the first video game player with the second video game player. Additionally or alternatively, other factors in matching the first video game player with the second video game player according to execution of the second model may include language type, accent, dialect, manner of speech, speaking speed, and/or speaking cadence.

In another aspect, a method includes accessing game engine data from the game engines of respective video game players, with the respective video game players including a first video game player. The method also includes analyzing the game engine data using a first model to determine that the first video game player is a video game coach candidate and, based on determining that the first video game player is a video game coach candidate, presenting a prompt at a first device of the first video game player regarding whether the first video game player would like to opt-in to a video game coach program. The method also includes receiving an affirmative response to the prompt and, based on the affirmative response, executing a second model to match the first video game player with a second video game player that the first video game player is to coach in gameplay. Based on the match, the method also includes facilitating a communication channel between the first device of the first video game player and a second device of the second video game player for the first video game player to coach the second video game player regarding a particular aspect of a video game.

In some example implementations, the method may also include analyzing the game engine data using the first model to determine that a third video game player is not a video game coach candidate regarding the particular aspect of a video game. Here the method may then include, based on a determination that the third video game player is not a video game coach candidate regarding the particular aspect of a video game, noting in a log that the third video game player is not a video game coach candidate regarding the particular aspect of a video game.

Also in some example implementations, the method may include executing the second model to use one or more clustering algorithms to match the first video game player with the second video game player. Thus, if desired the method may include providing, as input to the second model to execute the second model, data regarding play proficiency at a particular task that the second video game player is facing within a particular video game. Additionally or alternatively, the method may include providing, as input to the second model to execute the second model, data regarding language type, accent type, and/or dialect type associated with the first video game player.

Additionally, if desired, in some instances the method may include providing, as input to the first model to execute the first model, data regarding proficiency at the particular aspect of the video game in determining that the first video game player is a video game coach candidate.

In still another aspect, an apparatus includes at least one computer medium that is not a transitory signal. The at least one computer medium includes instructions executable by at least one processor system to execute a clustering model to match a first video game player with a second video game player that the first video game player is to coach in gameplay. The instructions are also executable to, based on the match, facilitate a communication channel between a first device of the first video game player and a second device of the second video game player for the first video game player to coach the second video game player regarding a particular aspect of a video game.

In some example embodiments, the instructions may also be executable to execute a second model to determine that the first video game player is a video game coach candidate. Here, based on execution of the second model to determine that the first video game player is a video game coach candidate, the instructions may be executable to present a prompt at the first device of the first video game player regarding whether the first video game player would like to be considered as a video game coach. If desired, responsive to receiving a response to the prompt that the first video game player would like to be considered as a video game coach, the instructions may be executable to begin parsing data associated with the first video game player to match the first video game player with the second video game player. For instance, the instructions may be executable to provide the data as input to the clustering model as part of execution of the clustering model.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 shows an example graphical user interface (GUI) with a prompt that may be presented to a video game coach candidate based on execution of a first artificial intelligence-based model identifying the person as a video game coach candidate consistent with present principles;

FIGS. 3 and 4 show other example GUIs that may be presented for the person to accept a specific coaching opportunity and to coach another player consistent with present principles;

FIG. 5 shows an example GUI that may be presented to prompt another player that digital communication with a video game coach is available consistent with present principles;

FIG. 6 shows an example GUI that may be presented on the other player's screen while engaged in a secure digital communication session with a video game coach consistent with present principles;

FIG. 7 shows example artificial intelligence (AI) architecture that may be used consistent with present principles;

FIG. 8 shows example overall logic in example flow chart format that may be executed by a device/gaming system consistent with present principles;

FIG. 9 shows an example settings GUI for a potential coach candidate to opt-in to potentially becoming a digital coach in the future consistent with present principles; and

FIG. 10 shows a schematic of example network architecture that may be used consistent with present principles.

### DETAILED DESCRIPTION

Among other things, disclosed below are devices and methods for technological processes related to network-enabled digital communications between video game players. An online venue may therefore be facilitated where players can connect with other gamers who are skilled at a particular task and can therefore act as a coach to help with the requesting player's skill development and advancement in the game.

For example, a player who gets stuck at a particular point in a game or simply wants to improve their skills may engage in a digital exchange with another player-expert who has demonstrated skill in the desired area. Players may be matched with expert coaches based on specific objectives, set parameters, and even defined prices that the requesting player is willing to offer for coaching assistance. Example requests that the players can input to the network, which may then be processed using large language models and natural language processing for determining tags for coach matching, may include “help me beat the boss,” “help me kill the dragon,” “evaluate my PVP loadout/settings”, etc. Thus, it is to be understood consistent with present principles that coaching may be provided not just for in-game tasks within the game environment or virtual game world itself, but also for assistance with navigating network, platform, and game menus, as well as other tasks that might be accomplished through a video game network offered by a console manufacturer and/or online cloud gaming provider.

Particular peer-to-peer coaching implementations consistent with present principles may even include screen-sharing of the requesting player's screen, and/or concurrent gameplay where the coach may either play alongside the requesting player in the same game instance or take control of the requesting player's own character to help coach the requesting player through demonstration. Upon completion of the coaching session, the requesting player can then submit renumeration directly from their online, in-network e-wallet, enabling the network to provide security measures to help ensure a secure transaction. Players may also have the opportunity to rate the service that their coach provided after the session is over.

Additionally, trust and safety in coaches may be facilitated by the technology disclosed herein. Thus, potential gameplay coaches may be vetted so that children and other protected classes of individuals may safely receive game coaching. In one example, eligibility to participate in the coaching program may be contingent on a review of the player's (potential coach's) identity and gameplay history. Verification of the coach's identity may take place using images of the front and back of a photo ID for the coach as well as live real-time facial images of the coach as sourced from a local camera. Facial recognition may then be executed to match the face from the photo ID to the face from the real-time images to confirm a facial match and hence verify the potential coach's identity. Additionally, the potential coach's identity (including info from the photo ID) may be cross-referenced with other online sources of identifying information. These processes may take place using a security application like Google Authenticator or Microsoft Authenticator, for example.

Additionally, the potential coach's moderation history on the manufacturer's gaming platform may also be used for vetting the potential coach, where mutes and blocks of the potential coach by others during regular gameplay may be examined. If the potential coach has received a threshold amount of mutes (e.g., more than one) and/or threshold amount of blocks (e.g., again more than one) within a most-recent threshold period of time (and/or over any given threshold period of time), the potential coach may eliminated from consideration as a coach candidate. Other aspects of the potential coach's moderation history on the gaming platform may also be considered, as well as the potential coach's moderation history across linked accounts. For example, moderation history of the potential coach for the potential coach's social media accounts may also be examined to see if the potential coach has been muted or blocked according to the thresholds above, which may also disqualify the potential coach from further consideration.

Other factors for the potential coach that may be examined include automatically detected and flagged behavior on the gaming platform and elsewhere (e.g., violent language or speech), as well as suspicious account activity (e.g., including suspicious financial transfers). A history check against other available databases may also be performed.

As an added layer of security for children and other protected classes, in some examples for the child/protected class individual to receive coaching from another gamer, the system may also require parental or guardian consent prior to usage by the protected individual. The consent may be provided by a linked but separate account for the parent/guardian themselves.

Present principles may therefore improve digital networking and digital communication while providing a unique and secure communication platform for seamless, real-time, ad-hoc, relevant digital communication between two (or more) video game players on a single network and platform. This in turn may help to eliminate potential points of digital attack, and also to facilitate communication at the moment the requesting player really wants it while still allowing that player to remain engaged in the game throughout. Coaches may even be screened for providing coaching assistance to protected classes of individuals, including children.

Prior to delving further into the details of the instant techniques, note that this disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

The term “a” or “an” in reference to an entity refers to one or more of that entity. As such, the terms “a” or “an”, “one or more”, and “at least one” can be used interchangeably herein.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

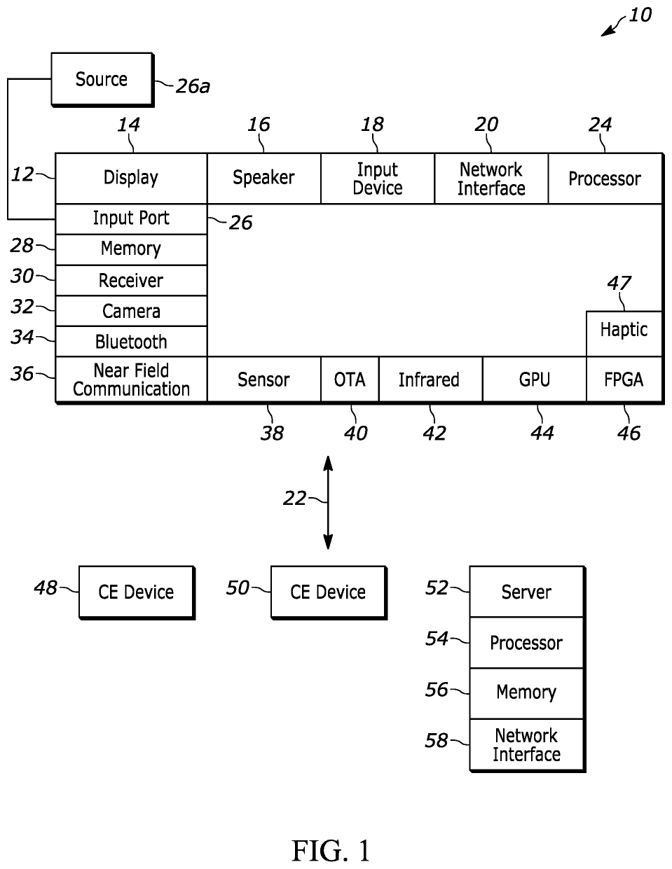

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors/processor system 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a specific type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, some models herein may be implemented by classifiers in particular.

As understood herein, performing machine learning may involve accessing and then training a model on training data to enable the model to process further data to make inferences. For example, back propagation may be used during training to change the weights of the model. An artificial neural network/artificial intelligence model trained through machine learning may thus include an input layer, an output layer, and multiple hidden layers in between that are configured and weighted to make inferences about an appropriate output.

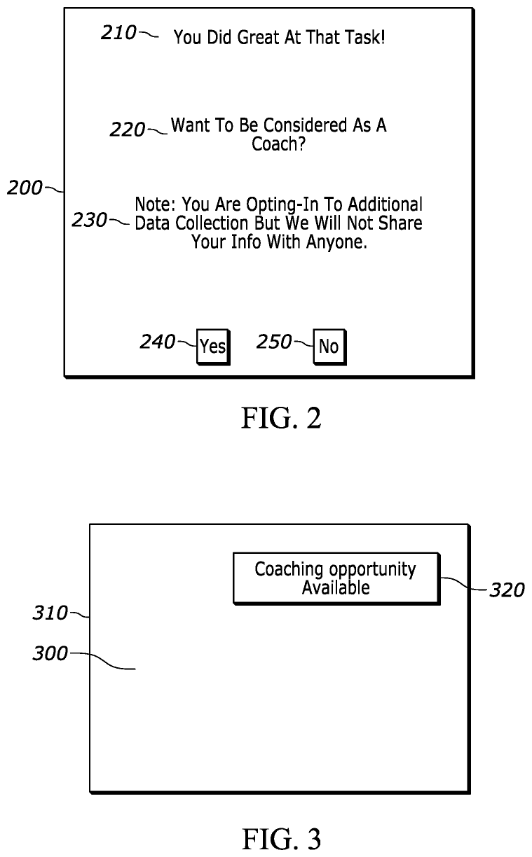

Turning now to FIG. 2, suppose a first video game player has succeeded at beating a certain non-player character or boss in a video game, or that the first player has completed some other task within the game such as navigating past a certain obstacle within the game or progressing past one of many checkpoints within the virtual world of the game. Consistent with present principles, an AI-based coaching candidate recognizer model may be executed to analyze game data from the first player's gameplay, as well as game data for other players on the same network who have played the same game. The data itself may be provided by each players' respective game engine after their respective play session has concluded, or may even be provided while the game plays out to the respective player in real time. The game sessions of the players need not be concurrent and the data may be collected over time.

To preserve the privacy of the players, in certain non-limiting embodiments the data may include only raw game controller input data (e.g., apart from any player-specific metadata). The input data may be analyzed to determine a proficiency level of the respective player in playing their own respective instance of the game to complete the relevant task within the game. If an output from the candidate recognizer model as related to a given player indicates a proficiency level at the particular task that is over a threshold amount, the system may determine that the respective player is a video game coach candidate. Therefore, assume in the present instance that an output from the candidate recognizer model indicates that the first player has been inferred as a video game coach candidate specifically for a task just completed based on the first player's proficiency level at completing that task being over the threshold amount.

In response to this output, the system (e.g., local console and/or cloud-based gaming platform) may present graphical user interface (GUI) 200 as shown in FIG. 2. The GUI 200 may be presented on the same display that the first video game player is using for gameplay. As shown, the GUI 200 may include an indication 210 that the first player did well in completing the last task in the game. The GUI 200 may also include a prompt 220 regarding whether the first player would like to be considered as a video game coach. An extra note 230 may also be included to indicate to the first player that they are opting-in to additional data collection but that the additional data will not be shared with anyone since it is only being used for determining coaching matches within the provider's game network.

If the first player wishes to opt-in and be considered as a potential coach for other players when the other players have difficulty with the same task at which the first player just succeeded, the first player may select the selector 240 to provide an affirmative response. Selection of the selector 240 may also command the system to take the first player back to the game, where the first player can continue playing the game while additional processing takes place in the background transparently to the first player (e.g., including execution of a clustering model at a cloud server to determine player/coach matches). However, further note that should the first player wish to not opt-in, the first player may instead select the selector 250 to be taken back to the game to continue playing the game without the first player being considered in the background as a potential coaching candidate (and hence without the additional data being collected for the first player).

Assuming the first player does indeed opt-in to be considered as a coach, the first player may continue to play the video game as represented in FIG. 3, with visual game content 300 being presented via a gameplay GUI 310. Then, at a later time when the system identifies a match between the online first player and a concurrently online second player that desires coaching assistance at the same game task at which the first player has already succeeded, a selector 320 may be dynamically presented at part of the GUI 310 to both prompt the first player that a coaching opportunity is available and to be selected by the first player to command the system to open a channel of communication between the two players for coaching to ensue. Note that the first and second players may have been matched together based on a variety of compatibility factors that will be discussed later.

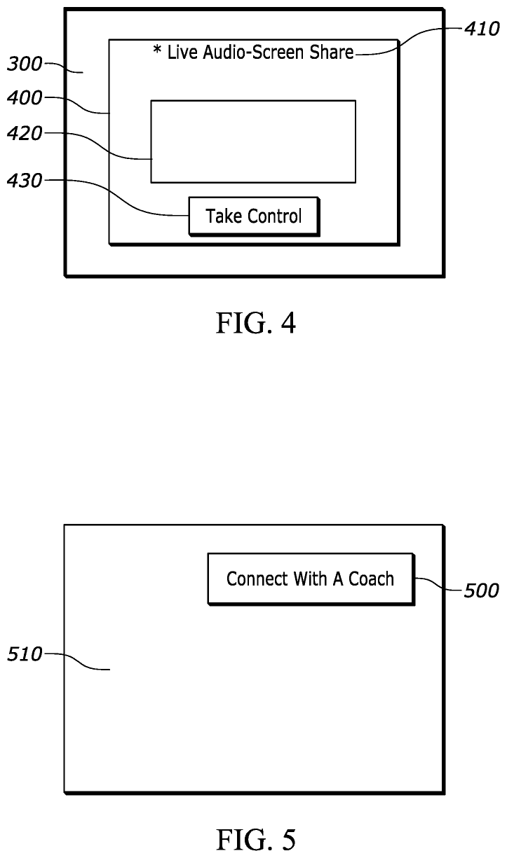

FIG. 4 then shows that a secure audio/video channel of communication has been opened between the first and second players over the same game network, with an overlay 400 being presented over top of the content 300. The overlay 400 may include a prompt 410 to notify the first player that an audio/video channel is open so that the first player knows that their voice and video is being streamed to the second player. An inset video stream 420 of the second player's real-time, live gameplay in the second player's own game instance (and according to the second player's own game field of view) is also shown since the second player is also streaming audio and video back to the first player's local device so that the first player can watch the second player's gameplay live in real time and hear the second player speak live in real time during the gameplay.

Thus, with a bi-directional audio-video game conference being established through the same game network that is already being used to facilitate each player's own individual gameplay, the first and second players may audibly converse with each other while the first player watches the second player actively engage in gameplay via the second player's own local client device. Note that if desired, to further aid in player privacy, the respective audio/video streams from each player's local client device may be encrypted using asymmetric key encryption and/or may be protected via other network security measures to protect the channel/conference from eavesdropping by others on the network.

Additionally, the first player might even select the selector 430 to take remote control of the second player's current game character (e.g., if the players verbally agree as recognized by the system) so that the first player can control the second player's game instance just as the second player might themselves. The first player can then remotely-control the second player's character within the second player's game instance to demonstrate a game move (or moves) that might result in success for the second player at completing or overcoming the relevant in-game task. Additionally or alternatively, the first player might even remotely-control the second player's character for the first player themselves to remotely complete the relevant task for the second player.

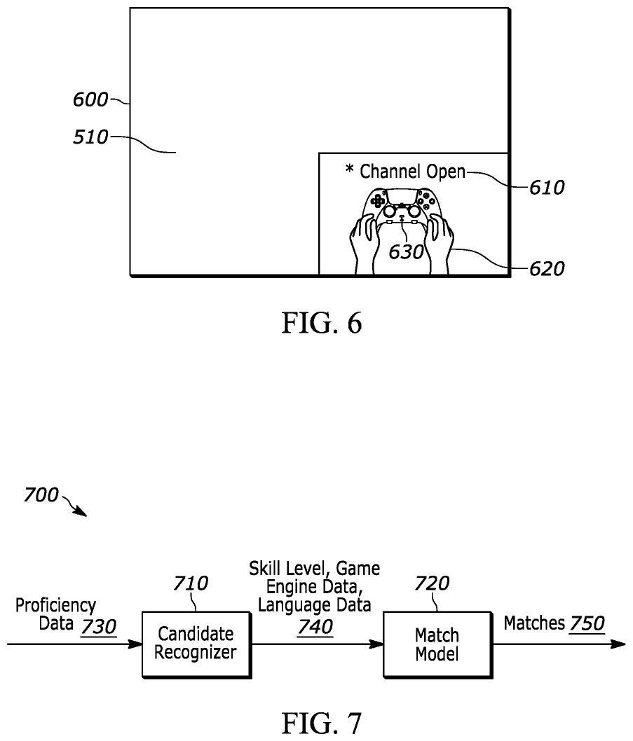

FIGS. 5 and 6 also demonstrate the digital player-coach networking of FIGS. 3 and 4, but from the perspective of the client device of the second player. First in reference to FIG. 5, again assume the second player is playing the same video game and is having trouble with completing or succeeding at a particular in-game task as mentioned above. The system may detect as much based on pre-set rules and/or thresholds. For example, the system may determine that the second player has experienced a threshold number of failed attempts at completing the task, or has exceeded a threshold amount of time from when the second player first began attempting the task. In response to detecting the second player as having trouble with the task, the system may present a selector 500 as shown overlaid on the second player's visual game content 510 in FIG. 5. The selector 500 may be selectable to submit a request to the system that the system match and connect the second player with a coach to help the second player in overcoming the in-game task with which the second player is struggling.

FIG. 6 then shows that responsive to selection of the selector 500 and the system subsequently determining a coaching match for the second player, an inset picture-in-picture video 600 of the first player (coach) may be presented live in real-time while the second player continues to play the game to try to succeed at the task with which the second player is having difficulty. Note that the video 600 may include a text prompt 610 to notify the second player that an audio and screen share channel is open so that the second player knows that their voice and video (e.g., gameplay screen share showing the video content 510) is being streamed to the first player.

The video 600 itself may be a livestream from a digital camera directed at the first player's hands 620 as the first player controls their own video game controller 630 from a remote location to demonstrate one input or a series of inputs to the controller 630 that the second player could then replicate on the second player's own controller to help the second player accomplish their in-game task. The first player's camera may therefore be located at a variety of locations within the first player's environment, such as on a headset being worn by the first player or on a stand-alone camera near the first player, with either camera connected to the game network to provide the livestream. Thus, the second player can watch the live video 600 of the first player and then try to mimic the same moves using the second player's own video game controller as connected to the second player's own game instance/game engine to accomplish the in-game task.

Turning now to FIG. 7, example artificial intelligence (AI) model architecture 700 is shown that may be used consistent with present principles. This architecture 700 may be constructed to, using a first model 710, recognize potential coaching candidates based on their own successful gameplay. The architecture 700 may also be constructed to, using a second model 720, match resulting coaches with players in need of coaching based on a variety of compatibility factors.

Beginning with the first model 710, it may be established as a candidate recognizer for recognizing potential coaches based on analysis of game engine data (e.g., including game video). As such, gameplay proficiency data 730 may be provided as input to it for the model 710 to determine whether a given player is a video game coach candidate. The data 730 may include video game controller inputs such as button and joystick inputs, voice inputs, touchscreen inputs, and other raw/pre-processed game data related to a given task within a particular video game (and not any player-specific metadata such as profile data, player name, IP address, etc.).

Various types of pattern recognition AI models may therefore be used for the first AI-based model 710, including recurrent neural networks and/or feed-forward neural networks. Different particular pattern recognition algorithms may also be used, including different classification, clustering, and regression algorithms. The first AI-based model 710 may be trained on one or more datasets of game videos of specific in-game tasks being performed and respective ground truth labels indicating success/failure at the task. In some instances, ground truth labels related to overall proficiency/skill level at completing the task as shown in each respective video may also be used.

During deployment, the model 710 may then output play proficiency data in the form of processed data indicating a success or failure inference for a given video input of a player performing an in-game task. The model 710 may also output an inferred overall proficiency/skill level and other relevant data for the particular task based on the respective video that is provided as input. Certain outputs from this model may then be selected by the system based on criteria such as success at the task and overall skill level at completing the task being over a threshold skill level. A respective player associated with a selected output may thus be established as a potential video game coach candidate for the particular in-game task shown in that player's video (as provided as input to the model 710).

Accordingly, selected outputs from the model 710 may then be fed into the AI-based coach matching model 720 as input data 740. The system executing the model 720 may also include other data as input to the model 720 as also represented in FIG. 7, including game engine data and/or video for both players in need of coaching as well as the potential coaches themselves.

The game engine data, video, and/or other inputs may then be analyzed by the system to determine playstyle, play speed, and other game performance metrics for each respective player or coach associated with the respective input. To this end, the model 720 may include one or more playstyle pattern recognition components that may themselves be established by deep learning models such as deep convolutional neural networks or other types of pattern recognition models. The playstyle pattern recognition component may thus be trained to recognize different players' playstyles, play speeds, and overall proficiency/skill levels at succeeding at various specific in-game tasks (for one specific video game, or for more than one video game). As such, one or more datasets may be used for training, where the dataset(s) may include videos of different specific in-game tasks being performed along with respective ground truth labels indicating an assigned playstyle, play speed, and/or overall proficiency/skill level for that video. Unsupervised learning and other learning techniques may also be used. Thus, during deployment, game video of a specific in-game task being attempted may be fed into the playstyle pattern recognition component of the model 720 to then receive an output of playstyle(s), play speed, and/or overall proficiency/skill level of the respective player at performing the relevant in-game task.

The results from the game engine data analysis (as provided by the playstyle pattern recognition component) may then be used by the model 720 to match a player and coach together based on criteria such as the same or similar proficiency/skill level, playstyle, and/or play speed for the relevant task. This allows for a match where, owing to the similar proficiency/skill levels, playstyle, and play speed of the coach and player, the coach can instruct the player on completing the in-game task in a way that's relatable and feasible for the player that is actually being coached.

Other criteria may additionally or alternatively be used for matching players with coaches. For example, the input data 740 may also include language data related to the respective player or coach, including language type, accent, dialect, manner of speech, speaking speed, and speaking cadence. These things may also help make the coaching experience more relatable and understandable to the player being coached. Examples of language type include English, Japanese, French, etc. Examples of accent type include British English accent, American English accent, Southern accent, New England accent, New York accent, etc. Examples of dialect include surfer dialect, hipster dialect, Australian lingo, and other localized dialects of words and grammatical constructions. Example manners of speech include direct, indirect, aggressive, passive, loud, soft, profane, etc. Coaches and players may therefore be matched based on having one or more of the foregoing criteria in common, as well as having similar speaking speeds and cadences (e.g., to within a threshold tolerance) and still other criteria in common, such as being similarly right-handed or left-handed (e.g., for video game controller control).

As it may be desirable to match a player and coach together based on as many criteria in common as possible, but also with the understanding that some criteria may not be weighted or favored as much as others, the model 720 may also include a discriminative AI component. The discriminative AI component may therefore include one or more recurrent neural networks, feed-forward neural networks, decision trees, etc. Different clustering algorithms may also be used to cluster similar players and coaches together based on the various criteria (and weights) that are used in a given implementation. Example clustering algorithms that may be used include density-based, distribution-based, centroid-based, and hierarchical-based clustering algorithms. As such, various unsupervised learning techniques may be used for training. Additionally or alternatively, supervised learning may be used via training using datasets of player/coach-specific data in one or more of the criteria above and respective ground truth player/coach combination match strength levels.

Thus, potential players-coach combinations where the respective player and coach share more traits in common may result in a higher match strength level being output by the discriminative AI component, while potential player-coach combinations with less traits in common may have a lower match strength level. Output 750 may therefore be provided by the model 720, with the output 750 indicating various match strength levels for various potential player/coach combinations (e.g., different player/coach combinations for some or all players and coaches that are currently online only, in examples where immediate coaching is to be provided at the request of a player). Additionally, to reiterate, note again that a given match strength level may be based on not just total traits in common, but cumulative score of the traits in common where certain traits/criteria are weighted higher than others.

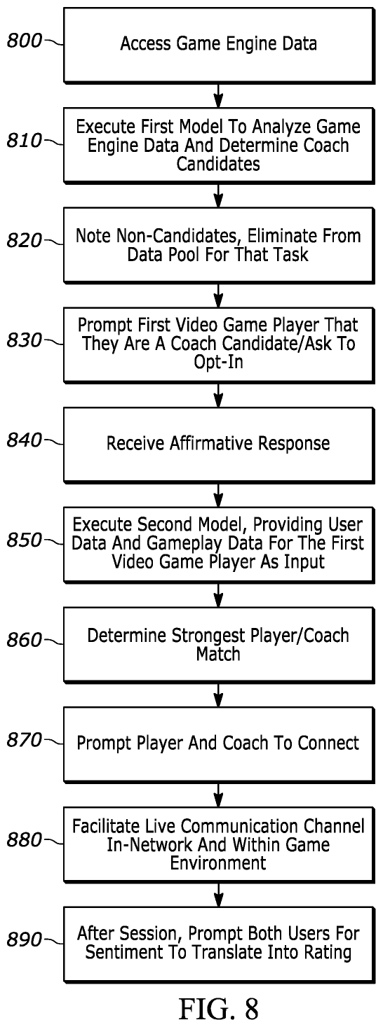

Turning now to FIG. 8, it shows example overall logic in example flow chart format that may be executed by a player/coach matching system consistent with present principles. Beginning at block 800, the system may access game engine data from the game engines of respective video game players, with each game engine executing its own instance of a same video game in a single-player or multi-player embodiment.

The logic may then proceed to block 810 where the system may execute a first model (such as the model 710 discussed above) to analyze the game engine data to determine that a first video game player is a video game coach candidate to ultimately be paired with a second player consistent with the disclosure above. But first, note that the logic may proceed to block 820 where, based on a determination that a third video game player is not a video game coach candidate, the system may note the third video game player in a system log along with any other determined non-candidates so that those players may be eliminated from the data pool of potential coaches for the relevant in-game task under consideration. This may help cut down on processing resources and energy consumed by execution of the second model.

The logic may then proceed to block 830 where the system may, based on determining that the first player is a video game coach candidate, present a prompt at a first device of the first player regarding whether the first player would like to opt-in to a video game coach program. For example, the prompt 200 of FIG. 2 may be presented at block 830.

From block 830 the logic may then proceed to block 840 where the system may receive an affirmative response to the prompt to, at block 850 based on the affirmative response, execute a second model (e.g., the model 720) to match the first player with a second player that the first player is to coach in gameplay. Though not shown, not here that a negative response to the prompt may result in the logic ending and/or may result in the potential coach no longer being considered while the system attempts to assemble/match other pairs for the relevant in-game task.

In any case, note that at block 850 the second model may be executed to use one or more clustering algorithms to parse the input data and match the first player with the second player. To do so, the system may provide, as input to the second model to execute the second model, data regarding play proficiency at a particular task that the second player is facing within a particular video game as set forth above. Additionally or alternatively, the system may provide, as input to the second model to execute the second model, data regarding respective language types associated with both the first and second players, respective accent types associated with the first and second players, respective dialect types associated with the first and second players, and other data for the first and second players for other criteria that might be used for matching consistent with present principles.

From block 850 the logic may then proceed to block 860. At block 860, based on different match strength levels output by the second model for different player/coach combinations (e.g., again for online players and coaches who have opted-in to the program), the system may determine a strongest player/coach match based on that match having the highest inferred match strength level output by the second model. The logic may then proceed to block 870 where the system may prompt the player and the coach to connect with each other, such as by presenting the prompts 320 and 500 described above.

Then, responsive to both the player and the coach responding to the prompt to participate in a live player/coach coaching session, the logic may proceed to block 880 where the system may facilitate a private, encrypted communication channel between the first device of the first player and the second device of the second player for the first player to coach the second player regarding a particular aspect of the video game with which the second player is struggling and at which the first player has already succeeded. This may include opening up a video conference between the two players and then routing encrypted audio/video streams from each client device to the client device of the other respective user.

Note here that should a given coach be prompted to provide coaching but that coach decline to do so, or decline to even respond to the prompt within a threshold amount of time, the system may instead proceed to a next-highest match strength level for a different player/coach combination that involves the same player needing assistance but a different potential coach with whom to pair with the second player. The coach from this second-highest strength level combination may then be prompted similar to the description above. If that potential coach also declines, the process may continue on to progressively lower strength levels for different player/coach combinations until the system receives an affirmative response to the coach's prompt from a potential coach.

If desired, from block 880 the logic of FIG. 8 may then proceed to block 890. At block 890, after the coaching session has ended, both the player and coach may receive separate prompts for what they thought of the interaction between the two of them for the system to then translate that verbal sentiment into a rating for the other respective person. The prompt might be visual or audible (e.g., “What did you think of your counterpart?”). The respective user may then audibly respond to the prompt using voice input as detected by a local microphone that is connected to the system. A third model such as a large language model, a natural language understanding algorithm, and/or other sentiment analysis software may then be executed on the voice input (e.g., after the voice input is converted to text using a speech-to-text algorithm) to infer a rating on a scale of one to five for the respective opposing player/coach from the coaching session.

So, for example, a rating of one may be for a strongly negative sentiment about the other user, a rating of two may be for a somewhat negative sentiment about the other user, a rating of three may be for a neural sentiment about the other user, a rating of four may be for a somewhat positive sentiment about the other user, and a rating of five may be for a strongly positive sentiment about the other user. These ratings may then be applied to a general gaming profile for the respective user that was rated, or even to a coaching program-specific profile for the respective user so that the rating(s) for that user may then be presented to others during future matchmaking (e.g., as part of the prompts 320 or 500 when a player/coach is deciding whether to begin a subsequent session with the relevant user).

Though not shown in FIG. 8, also note that other post-session processing may also be executed after the first and second players conclude their coaching session. For example, if the second player ultimately beats the game, earns a trophy, or receives some other reward, an asterisk may be presented next to the trophy or other reward in the second player's e-trophy cabinet, profile accomplishments list, tournament standing list, or game rankings list. The asterisk may thus denote that the second player received external assistance from someone else to accomplish the feat. Or the results of the second player's game instance might not even be entered in a tournament standing list or game rankings list, or used for certain other competitions, if the second player got external help from a coach. Yet in other instances, such as tournaments just for fun, no asterisk may be noted for the second player and the second player may be included in the game/tournament rankings list.

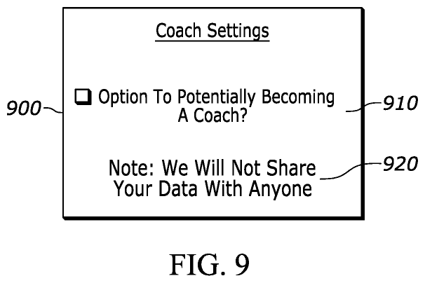

Now in reference to FIG. 9, it is to be understood that in addition to executing the first model of FIG. 8 to identify a potential coach candidate and then prompting that player that they might want to become a coach, players may themselves opt-in to being considered as a coach without being prompted by the system. As such, the settings GUI 900 of FIG. 9 may be presented for a given player to opt-in. The settings GUI 900 may be presented as part of a system settings screen or game settings screen, for example.

As shown in FIG. 9, the GUI 900 may include an option 910 that may be selected for the player to opt themselves in to being considered as a coach candidate (e.g., based on execution of the second model of FIG. 8). A note 920 may also be presented indicating that the platform's operator will not share the additional personal data that will be collected from an opt-in with any third parties for privacy reasons.

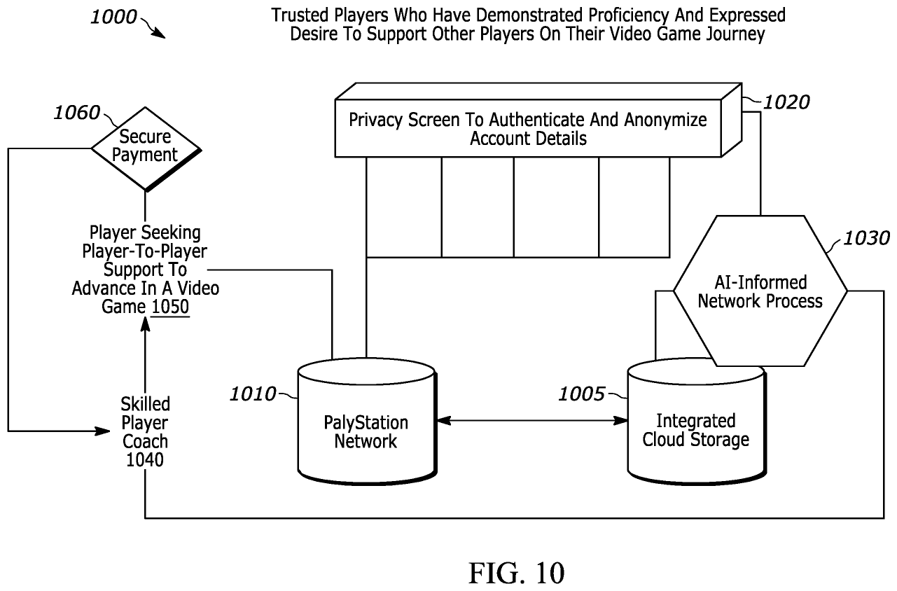

Continuing the detailed description in reference to FIG. 10, it illustrates example network architecture that may be used consistent with present principles. As shown, data 1000 may be stored in integrated cloud storage 1005 on the network 1010, with the data 1000 being related to trusted players who have demonstrated proficiency at a given task and expressed a desire to support other players in their own video game journey (e.g., by responding affirmatively to the prompt 200 or opting-in themselves through the settings GUI 900). As stored on the network 1010, the data 1000 may have been processed through a privacy screen 1020 or other algorithm that authenticates the trusted players for security and also anonymizes any account details/profile data for privacy.

AI-informed network processes 1030 may then be executed, including the first and models described above in reference to FIGS. 7 and 8. These processes 1030 may therefore be executed at a cloud-based server for the gaming platform's provider, and/or may be executed at a client device such as an end-user's own local game console, in any appropriate combination. The processes 1030 may then be used to infer an output 1040 of a skilled coach from amongst the available coach candidates to then match that coach with a player 1050 seeking player-to-player support to advance in a video game. A secure payment module 1060 may then be used to arrange for renumeration being provided by the player seeking support, where the renumeration might then be divided between the network host/platform provider and the coach themselves. Renumeration may therefore be provided on a subscription basis or even per-session basis, with renumeration being verified beforehand and securely transferred wallet-to-wallet owing to everything being conducted on the same single network managed by the platform provider.

While the particular embodiments are herein shown and described in detail, it is to be understood that the subject matter which is encompassed by the present invention is limited only by the claims.

What is claimed is:

1. An apparatus, comprising:
at least one processor system configured to:
execute a first model to determine that a first video game player is a video game coach candidate;
based on execution of the first model to determine that the first video game player is a video game coach candidate, present a prompt at a first device of the first video game player regarding whether the first video game player would like to be considered as a video game coach;
receive an affirmative response to the prompt;
based on the affirmative response, execute a second model to match the first video game player with a second video game player that the first video game player is to coach in gameplay; and
based on the match, facilitate a communication channel between the first device of the first video game player and a second device of the second video game player for the first video game player to coach the second video game player regarding a particular aspect of a video game.

2. The apparatus of claim 1, wherein the second model uses one or more clustering algorithms to match the first video game player with the second video game player.

3. The apparatus of claim 1, wherein the second model is executed to use play proficiency at a particular task that the second video game player is facing within a particular video game as a factor in matching the first video game player with the second video game player.

4. The apparatus of claim 1, wherein the second model is executed to use language type as a factor in matching the first video game player with the second video game player.

5. The apparatus of claim 1, wherein the second model is executed to use accent as a factor in matching the first video game player with the second video game player.

6. The apparatus of claim 1, wherein the second model is executed to use dialect as a factor in matching the first video game player with the second video game player.

7. The apparatus of claim 1, wherein the second model is executed to use manner of speech as a factor in matching the first video game player with the second video game player.

8. The apparatus of claim 1, wherein the second model is executed to use speaking speed as a factor in matching the first video game player with the second video game player.

9. The apparatus of claim 1, wherein the second model is executed to use speaking cadence as a factor in matching the first video game player with the second video game player.

10. The apparatus of claim 1, wherein the first model is executed to use play proficiency at the particular aspect of the video game in determining that the first video game player is a video game coach candidate.

11. A method, comprising:
accessing game engine data from the game engines of respective video game players, the respective video game players comprising a first video game player;
analyzing the game engine data using a first model to determine that the first video game player is a video game coach candidate;
based on determining that the first video game player is a video game coach candidate, presenting a prompt at a first device of the first video game player regarding whether the first video game player would like to opt-in to a video game coach program;
receiving an affirmative response to the prompt;
based on the affirmative response, executing a second model to match the first video game player with a second video game player that the first video game player is to coach in gameplay; and
based on the match, facilitating a communication channel between the first device of the first video game player and a second device of the second video game player for the first video game player to coach the second video game player regarding a particular aspect of a video game.

12. The method of claim 11, comprising:
analyzing the game engine data using the first model to determine that a third video game player is not a video game coach candidate regarding the particular aspect of a video game; and
based on a determination that the third video game player is not a video game coach candidate regarding the particular aspect of a video game, noting in a log that the third video game player is not a video game coach candidate regarding the particular aspect of a video game.

13. The method of claim 11, comprising:
executing the second model to use one or more clustering algorithms to match the first video game player with the second video game player.

14. The method of claim 11, comprising:
providing, as input to the second model to execute the second model, data regarding play proficiency at a particular task that the second video game player is facing within a particular video game.

15. The method of claim 11, comprising:
providing, as input to the second model to execute the second model, data regarding one or more of: language type associated with the first video game player, accent type associated with the first video game player, dialect type associated with the first video game player.

16. The method of claim 11, comprising:
providing, as input to the first model to execute the first model, data regarding proficiency at the particular aspect of the video game in determining that the first video game player is a video game coach candidate.

17. An apparatus, comprising:
at least one computer medium that is not a transitory signal and that comprises instructions executable by at least one processor system to:
execute a clustering model to match a first video game player with a second video game player that the first video game player is to coach in gameplay; and
based on the match, facilitate a communication channel between a first device of the first video game player and a second device of the second video game player for the first video game player to coach the second video game player regarding a particular aspect of a video game.

18. The apparatus of claim 17, wherein the instructions are executable to:
execute a second model to determine that the first video game player is a video game coach candidate; and
based on execution of the second model to determine that the first video game player is a video game coach candidate, present a prompt at the first device of the first video game player regarding whether the first video game player would like to be considered as a video game coach.

19. The apparatus of claim 18, wherein the instructions are executable to:
responsive to receiving a response to the prompt that the first video game player would like to be considered as a video game coach, begin parsing data associated with the first video game player to match the first video game player with the second video game player.

20. The apparatus of claim 19, wherein the instructions are executable to:
provide the data as input to the clustering model as part of execution of the clustering model.
